(19) United States
(12) Patent Application Publication
(10) Pub. No.: US 2004/0151470 A1
(43) Pub. Date: Aug. 5, 2004

(54) Method for individually controlling and influencing the playback from a data recording medium

(76) Inventors: Marc Schnabel, Eschwege (DE); Bernd Rudolf, Eschwege (DE); Peter Woop, Eschwege (DE)

Correspondence Address: WILLIAM COLLARD, COLLARD & ROE, P.C., 1077 NORTHERN BOULEVARD, ROSLYN, NY, 11576, US

(21) Appl. No.: 10/477,969

(22) PCT Filed: May 13, 2002
(86) PCT No.: PCT/DE02/01713

(30) Foreign Application Priority Data
May 18, 2001 (DE) 10124702.8

(51) Int. Cl. G11B 27/00; H04N 5/91

(52) U.S. Cl. 386/52; 386/95

(57) ABSTRACT

The invention relates to a method for individually controlling and influencing the playback of film sequences from a data recording medium in real time involving a navigation effected by menu control. In order to enable the playback of information of an older data recording medium in an updated or edited form, the invention provides a method during which the sequence of the playback is altered, extended and/or provided with additional information during one or every other playback process. The method thereby enables the real-time playback of information, e.g. of a film, with a linking of additional stored information. In this manner, an existing film, for example, can be supplemented with detail information that would not have been able to be depicted without linking.

The invention relates to a method for individually controlling and influencing the playback of film sequences from a data recording medium in real time, involving a navigation effected by means of menu control.

Data recording media that have a high data density, for example CD-ROMs or DVDs, which have an advantageous price/memory space ratio and can be used as video DVDs, audio DVDs, computer data media, or as a mixture of these possibilities of use, are suitable for use of the method. This therefore involves a modern data medium that offers many different possibilities of use. A video DVD stores high-quality video and audio material for direct access without time delay, in other words complicated rewinding or searching, and makes the material available for read access within a short period of time. Because of its properties, it is also suitable for other applications in which “film” as a medium plays a significant role, in addition to the known area of use of “movie DVDs,” for example in product presentations, documentation, E-learning systems, and other business applications. Since a CD or a DVD does not deteriorate even when played back many times, it is also very well suited for archiving and transport of video material, but DVDs are a “write once medium,” therefore the disadvantages are obvious.

Current data and data that change frequently should therefore not be stored on a DVD, because the risk is too great that the data will be obsolete at the time of use. The largest amount of changeable data is currently transmitted via networks, preferably via the Internet. The disadvantages of the World Wide Web are generally known. Because of different band widths and an insufficiently great band width at the transfer point to the end user, transmission of large amounts of data cannot take place in real time. Therefore it is currently not possible to play high-quality film material via the Internet, and this will also not be possible for the foreseeable future.

On conventional data media, for example as DVDs or CD-ROMs, a menu program is generally stored, which allows the stored data to be played back. For example, there are generally several film sequences on a DVD, and when a DVD is placed into a DVD player, a graphical user interface, the so-called menu program, is loaded. The menu program makes individually selectable menu points available and allows specific film sequences to be started by selecting the corresponding menu point, or allows another sub-menu with other menu points to be called up. The functions of the individual menu points are stored on the DVD, if applicable in standardized form. Such DVDs can be played back using either a hardware player or a software player, whereby a hardware player is a stand-alone device that is connected with a playback medium, for example a television set, and can play back both the DVD menu and the film sequences. A software player is software for a specific operating system that allows DVDs to be played back on a computer monitor, in connection with a sufficiently fast PC and a PC DVD drive. In this connection, the menu program and the menu points that are stored on the DVD are shown on the computer monitor, and the selection points can be selected using a mouse or another input device. In this connection, the menu programs used, similar to a video recorder, make it possible to start or stop the playback process, or to continue it at the same or a different location. When actual movies are involved, this method of procedure might be sufficient, but if data that must constantly be updated is to be presented in audio and/or video form, the case very rapidly occurs that at least part of the data is obsolete and must be updated. The publisher of the data medium therefore only had the possibility of sending new data media to the customers, as needed, whereby this not only results in high shipping costs, but also requires the production of new data media. If special data are involved, which must constantly be updated and replaced as the result of the rapid further development of specific products, this method of procedure is economically untenable.

Although DVDs have a high data recording density and therefore entire movies can be stored on one or, if necessary, two DVDs, they are purchased but generally not used very much. The cause is that after the same film has been viewed several times, the individual film scenes are very well known and do not offer sufficient incentive to play them back over and over again. This is attributable, among other things, to the fact that the existing films can be played back only in a predetermined sequence and that no updating or editing is possible.

The present invention is based on the task of indicating a method with which existing film material on a data recording medium can be presented in a new way, in an appealing form.

According to the invention, it is provided, in order to accomplish this task, that the sequence of playback is altered, extended, and/or provided with additional information during a first and/or every subsequent playback process.

The particular feature of the indicated method consists of replacing older data with newer data, i.e. including newer data in the playback process that are stored, for example, on another data medium or on another accessible medium, in order to thereby alter or extend the playback process, or to provide it with additional information, if applicable. In this connection, the particular possibility exists to provide a link between existing stored films and additional information, for example images, texts, sound, or all other types of digital data, and to link them with the film with reference to running time or specific objects. In this manner, an existing film can be supplemented with detail information, for example, that would not have been able to be depicted without linking. The data required for this purpose can be stored in a web server, for example, or they can be made available on other data recording media, and allow any desired linking during the running time of the film, for example with data that are downloaded from the Internet, thereby making subsequent modification possible. The particular advantage lies in linking the film or film segments with other film segments or other digitally stored data that have not existed in this form until now. Another significant advantage consists of no longer having to play an existing film in linear form, in other words from the beginning to the end, but rather being able to jump directly to individual scenes of the film. Furthermore, film scenes can be re-cut, in real time, so that existing film material can be brought together in a new way, in any desired manner, to produce a new running time, for example in order to emphasize the area of concentration of a topic, which can, however, be constantly updated and edited. In this connection, a link between one film and another can take place, for example, in iterative form, which corresponds to the classical cutting process, whereby there can be any desired number of cutting sequences for one and the same video material, which can also be run off in any desired manner, since the starting material is not modified. In addition, data downloaded from the Internet, for example, can be subsequently modified, while the film is running, or can be restructured. In addition, there is the possibility of linking one film with another in recursive form, and this completely new form of cutting allows the observer himself/herself to determine the content of the film at the running time, whereby an action can be triggered by means of manual intervention, which action can be used for switching to a different film sequence or for playing detailed information about specific products. After the requested data have been transmitted, or after the additional film sequence has been completed, the main film is continued exactly at the point at which it was previously interrupted. This recursive navigation of the film can take place in as many steps as desired, to the depth desired, and opens up previously unknown possibilities. This makes it possible, for example, to completely revise a film, whereby the data required for this are either available on another data recording medium, or can be downloaded from the Internet, in current form.

If a menu program is supplied with a video DVD, this program can be deactivated or overridden by an existing menu control, according to the present method, so that the required intervention can take place. Furthermore, the menu control can be influenced by an external control program, which is downloaded from the Internet, for example, or acts on the menu control directly, from the Internet. The navigation, i.e. the control of the playback process can, in this connection, be determined by film as the main medium or by an external control program. The method described thereby forms a bridge between a network and a DVD and essentially creates a one-time link between the film data, the text data, and the video data during playing. Furthermore, it allows inclusion of the DVD in web contents in any consequence [sic?—should be sequence?], whereby web contents with film elements can supplement the existing data of the DVD or can utilize the DVD film as an informal basis for calling up web contents and using elements of the film as navigation.

In a particular embodiment of the invention, it is provided, in this connection, that manual interventions of the observer, for example static or dynamic film markings, or calling up data from the Internet, can be stored in a file, together with other data from the film, in order to document the changes, or to keep the data obtained with regard to specific procedures available so that they can be called up at any time.

The menu control can be stored and called up from the data recording medium or a playback device, for example a PC, at least in part. Because the data recording medium can be identified by means of an individual recognition code, the menu control, by evaluating the recognition code, can select a specially modified playback variant that is dependent, for example, on how current the data are, or that requires and plays back only part of the stored data for a special purpose of use, for example for a film presentation.

In a particular embodiment of the invention, it is provided that the menu control produces a link to the Internet and requests further data from the manufacturer or publisher of the data recording medium, using the recognition code, and takes these into consideration during playback. This additional advantageous embodiment of the method for playing back data from a data carrier takes advantage of the technical possibilities of the Internet in the form that data on the data medium that require updating can be queried by the manufacturer or publisher of the data recording medium, by way of the recognition code, and taken into consideration during playback. This means that it is no longer necessary to replace the data recording media at regular intervals and to send them to the users, and instead, older data recording media can be used, which allow updated playback by way of the menu control and an external control program.

In this connection, it is provided, in advantageous manner, that the menu control is influenced by a control program located on the web server, and that playback of the stored data is altered. The control data can be stored, at least in part, on an external data processing device, for example a web server, which is connected with the Internet, and controls the menu control via the Internet. In this connection, a web server of the publisher of the data recording medium or another server connected with the Internet can be involved. The control program allows altering the sequence of playback, extending it if necessary, or adding additional information, in advantageous manner. In particular, this can involve technical detail information, purchase addresses, other information sources, or further information, which can be called up if needed.

In another particular embodiment of the invention, it is provided that the playback is interrupted by the menu control and, in particular, by the control program, and that additional data are inserted into the playback process, superimposed, or played back as a replacement, by way of the internet, for example the web server or a presentation computer. This method is preferred in updating films, for example with newly created film scenes, in the case of presentation computers for playing back data relating to a corporate profit or other current information, which can be constantly updated centrally, by way of the Internet, and adapted to current needs, whereby all of the insertions and superimpositions can be performed in the playback process and, in particular, older data that are no longer required can be skipped. It is particularly advantageous that additional audio and/or video sequences can be downloaded from the web and played back, using the menu control with which data are downloaded from the Internet, and that these can be video files, text files, or film sequences, for example, and that there is a possibility, in varied form, of supplementing the existing, older data with newer data from the web server, or of superimposing the newer data on them.

In another particular embodiment of the invention, it is provided that still or moving images can be accessed with the mouse pointer, for example, in order to select a specific object and request additional information about it, for example by way of the web server. The selection of specific objects from still or moving images, using the mouse pointer, and the possibility of calling up additional information about the object, expands the previously existing possibilities in a greatly varied form. For example, while a specific film sequence is being played, an interested observer can select an object, which might only be a pair of sunglasses, a motorcycle, or another object, for example, and request further information about it, whereby the menu control undertakes an identification of the selected object and either displays the stored information directly, in targeted manner, or sends a query via the Internet and then can display the information.

The access can take place manually, by the observer, or it can also be started and controlled automatically, after recognition of the recognition code of the data medium, whereby the control can, of course, be expanded by way of the web server. In this manner, it is possible to display information about all of the goods and products shown in the film and, if necessary, to download additional information from the web. By means of the direct access to the web server, there is the possibility of placing an order in the simplest form. Alternatively, there is the possibility that the control program that influences the menu program is stored in a presentation computer, for example at a trade show, within a corporate building, or on other devices required for storing data, and that it controls the playback while taking the current presentation display into consideration.

The newly developed software based on the method according to the invention furthermore allows playback of a DVD on a PC system. This, like any other software player, has the possibility of displaying and using the menu structure stored on the DVD. The existing scope of functions is supplemented, according to the invention, so that the individual functions of the specific menu points of the DVD are ignored when it is selected, and instead, other functions are performed. These functions can include, for example, calling up specific film sequences with a specific time code (jumping to any desired location of the DVD), calling up web sites, calling up data that are stored separately, for example from the DVD or on the PC or a connected network. In this connection, the data can also be called up via the Internet. Likewise, there is the possibility of undertaking the start of any desired application on the PC with any desired parameters, and allowing control or communication with a peripheral by way of one or more interfaces of the PC.

During playback, the program can automatically carry out the aforementioned functions, without user intervention, [with regard to] certain film sequences as a function of the time code, in other words can implement the playing time and the displayed frame in the respective second.

During playback, the software can stop certain film sequences as a function of the time code and can offer the currently played back film sequence and the currently displayed image as a menu. In this connection, there is the possibility of selecting as many regions as desired, using an input device, for example a mouse, whereby the functions described above can be performed subsequently.

During playback, the current image can additionally be used as a menu, for example in order to select individual objects, persons, items, or other freely selectable regions of the film sequence as menu points. If the object in question moves during playback of the film, the selection point is moved along with it, so that the object in the film becomes the representation of a menu point for the user. This means that the person or item in question can be selected and clicked on at any time. If a point is selected, the functions described above can also be performed. The size of the menu points is freely changeable, whereby the path that the menu points have traveled is freely selectable and can run in a straight and/or a curved line.

It should be emphasized as being particularly advantageous that in the case of an existing network connection, for example by way of the Internet, any desired film sequences with any desired image formats can be imported, for example using the streaming process, and can be played back like the film sequences of the DVD. The special functions described above can also be available in the playback of these film sequences.

Furthermore, a shopping basket function can be integrated into the menu control, which undertakes the selection and storage of individually displayed objects. The stored list of the selected objects can be processed further to produce an order, an inquiry, or a printout as an information medium. For this purpose, the data are transmitted via a network, for example the Internet, stored, and printed out.

To perform the aforementioned functions, the playback, particularly of a video sequence, is interrupted, and special product information about the objects and persons present in the film, or other information, is downloaded from the web server, if necessary, and displayed, whereby after the additional information has been presented, manual interventions can be performed by the observer or listener, for example in order to conduct a dialog or to place an order.

In this connection, it is provided that during playback, individual objects, persons, or the like can be identified by means of the inclusion of film markings and, in the case of moving images, can be followed by means of having the film markings follow them, while at the same time, the information is called up and displayed.

The method described is particularly suitable for use by service technicians, in order to download the most current and latest information for the service technician, by way of the Internet, from the company in question, and to update it, if necessary. In this manner, the service technical can obtain all the necessary information, in the case of new equipment, that he might need for a repair, for example, and at the same time there is the possibility that the service technician can store his own experience and knowledge in connection with his activity, for example with regard to the menu control, on the web server, so that other service technicians can benefit from his experience and knowledge. This creates the possibility of performing a speedy and cost-effective repair, within the shortest possible period of time, if applicable.

Another case of use exists, for example, in the business of replacement parts for cars, in order to inform customer service employees and customer service technicians about the most current replacement parts by means of access to the web server of the parts supplier, and to directly call up this information.

Furthermore, the method is also well suited for use in informative events or presentations, for playback of technical information and explanations, whereby any updating is centrally administered on the web server, and no intervention is required in the presentation room, if the playback process is carried out using the menu control and an external control program.

Also, use [of the method] is particularly advantageous in the case of reference works that are subject to constant updating, and are in need of supplements or replacements after having been published. If a DVD or a CD-ROM is used, the possibility therefore exists of downloading the latest and most current information directly from the web, by way of the Internet, and making it available.

The examples listed are, of course, not exhaustive, and can be extended as desired. The method indicated for controlled and individual playback of data from a data recording medium, using the Internet and a connected web server, indicates an inexpensive and very modern method for replacing obsolete information as quickly as possible, for the first time. The use [of the method] can therefore extend over wide areas of technology and the transmission of information.

1. Method for individually controlling and influencing the playback of film sequences from a data recording medium in real time, involving a navigation effected by means of menu control,
characterized in that
the sequence of playback is altered, extended, and/or provided with additional information during a first or every subsequent playback process.

2. Method according to Claim 1,
characterized in that
film cutting takes place in iterative or recursive form, whereby the content of the film can be influenced by an observer during its running time.

3. Method according to Claim 1 or 2,
characterized in that
an existing menu control of the data recording medium can be deactivated and/or overridden by the menu control.

4. Method according to Claim 1, 2, or 3,
characterized in that
the menu control can be influenced by an external program.

5. Method according to Claim 4,
characterized in that
the navigation takes place by means of film as the main medium or an external control program.

6. Method according to Claim 5,
characterized in that
a new cut of the film takes place in real time, whereby individual film sequences can be selected directly, using the time code and the existing chapters.

7. Method according to one or more of claims 1 to 6,
characterized in that
manual interventions of the observer, for example static or dynamic film markings, or calling up data from the Internet, can be stored in a file, together with additional data of the film.

8. Method according to one or more of claims 1 to 7,
characterized in that
the menu control is stored at least in part on the data recording medium or a playback device, and can be called up.

9. Method according to one or more of claims 1 to 8,
characterized in that
the data recording medium can be identified by way of an individual recognition code and that the menu control selects a special playback variant using an evaluation of the recognition code.

10. Method according to one or more of claims 1 to 9,
characterized in that
the menu control produces a connection to the Internet, and calls up additional information from a manufacturer or publisher of the data recording medium, using the recognition code, and takes this into consideration during playback.

11. Method according to one or more of claims 1 to 10,
characterized in that
the menu control is influenced by a control program located on the web server and alters the playback of the stored data.

12. Method according to one or more of claims 1 to 11,
characterized in that
the control program is stored, at least in part, on an external data processing device, which is connected with the Internet and influences the menu control via the Internet.

13. Method according to one or more of claims 1 to 12,
characterized in that
the playback is interrupted by the menu control and the control program and that additional information is inserted into or superimposed on the playback process, or played back as a replacement, by a web server or a presentation computer, via the Internet.

14. Method according to one or more of claims 1 to 13,
characterized in that
additional data, text, audio and/or video sequences can be downloaded from the web and played back, using the menu control, and that these are video files, text files, sounds, or film sequences, for example.

15. Method according to one or more of claims 1 to 14,
characterized in that
existing, older data on the data recording media are supplemented and/or replaced with newer data from the web server, by the menu program.

16. Method according to one or more of claims 1 to 15,
characterized in that
film sequences currently being played back automatically trigger certain functions, without user intervention, as a function of the time code, or that the film sequence currently being played back stops and offers the image currently being displayed as a menu point, in order for a manual user intervention to be performed.

17. Method according to one or more of claims 1 to 16,
characterized in that
still or moving images can be accessed by means of a mouse pointer, in order to select a specific object and request additional information about it.

18. Method according to Claim 17,
characterized in that
the control program that influences the menu program is stored in a presentation computer located at a trade show or within a corporate building, on a web server of the publisher of the data recording media, or on other devices required for storing data.

19. Method according to Claim 18,
characterized in that
the playback of video or film sequences is interrupted, and special product information about the objects and persons present in the film, or other information, is downloaded from the web server and displayed.

20. Method according to one or more of claims 1 to 19,
characterized in that
a shopping basket system is integrated into the menu control, which provides for the selection and storage of specific objects, in order to request information, place an order, or make an inquiry, whereby the data are transmitted via a network, stored, and can be called up.

21. Method according to one or more of claims 1 to 20,
characterized in that
after the additional information has been presented, manual interventions can be performed by the observer or listener, for example in order to conduct a dialog or to place an order.

22. Method according to one or more of claims 1 to 21,
characterized in that
during playback, individual objects or persons can be marked by inserting film markings and, in the case of moving images, can be followed by moving the film marking.

23. Method according to one or more of claims 1 to 22,
characterized in that
additional information about the marked objects or persons can be requested and displayed.

24. Method for individually controlling the playback of data and film sequences according to one or more of claims 1 to 17 for a service technician, whereby the most current and latest information can be downloaded from the web server of the company in question, and updated, via the Internet, for the service technician.

25. Method according to one or more of claims 1 to 24,
characterized in that
the service technician stores his own experience and knowledge in connection with his activity on the web server, by way of the menu control.

26. Method for individually controlling the playback of data and film sequences according to one or more of claims 1 to 17 in the business of replacement parts for cars, in order to give customer service employees and customer service technicians information about the most current replacement parts by means of access to the web server of the parts supplier.

27. Method for individually controlling the playback of data and film sequences according to one or more of claims 1 to 17 in informative events or presentations, for playback of technical explanations or general information, while at the same time updating the information by means of the web server of the information provider.

28. Method for individually controlling the playback of data and film sequences according to one or more of claims 1 to 17 for reference works, for constantly updating obsolete information.
